(19) United States
(12) Patent Application Publication
(10) Pub. No.: US 2008/0212091 A1
(43) Pub. Date: Sep. 4, 2008

(54) Light source unit and spectrum analyzer

(75) Inventors: Masato Tanaka, Kanagawa (JP); Tetsuya Nakanishi, Kanagawa (JP); Tetsuya Haruna, Kanagawa (JP); Masaaki Hirano, Kanagawa (JP); Toshiaki Okuno, Kanagawa (JP); Takashi Sasaki, Kanagawa (JP); Masashi Onishi, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 12/010,212

(22) Filed: Jan. 22, 2008

(30) Foreign Application Priority Data
Jan. 25, 2007 (JP) 2007-015373

(51) Int. Cl. G01J 3/447; H01S 3/10

(52) U.S. Cl. 356/327; 372/26; 372/27

(57) ABSTRACT

A light source unit and a spectrum analyzer are provided in which the influence of interference can be reduced under conditions where light is separated into spectral components. A spectrum analyzer 1 is equipped with a light source unit 2 for irradiating light onto sample A, a detector unit 3 for detecting the light reflected, scattered, or transmitted from the sample A, and a sample stage 4 on which a sample A is placed. A wide band light source 20 generates wide band light P1 such as supercontinuum light (SC light). Also, the light source unit 2 has an interference suppressing means for suppressing the interference of each wavelength component of the wide band light P1.

### BACKGROUND OF THE INVENTION

1. Field of the Invention

The present invention relates to a light source unit and a spectrum analyzer.

2. Description of the Background Art

A spectrum analysis requires a light source which outputs light having a wide band. Halogen lamps and LEDs have widely been used as such light sources. However, these light sources had shortcomings that their power per unit wavelength and unit area was too small to precisely analyze a sample in some cases. On the other hand, supercontinuum light (SC light) can precisely analyze a small amount of samples because of its superior light focusing property and is expected as a light source for spectrum analysis. An example of the light source unit for emitting SC light is disclosed in International Patent Application Publication No. WO 2006/106669 A1.

In general, it has been considered that, even if light is formed based on laser beams, interference is hardly observed in the case of light having a wide band because interferences at respective wavelengths overlap and offset each other. However, under the conditions where the wideband light is separated into its spectral components in spectrum analysis, the coherence tends to increase because the spectral component at the respective position is limited. Since the transverse mode of light, such as SC light, generated by means of laser beams is single, interferences conspicuously appear even in the optical system where the interferences are not apparent in the case of light generated by a halogen lamp or a LED. Therefore, when SC light is used for the spectrum analysis, an error due to interference will occur to the result of measurement.

### SUMMARY OF THE INVENTION

The object of the present invention is to provide a light source unit and a spectrum analyzer in which the influence of interference can be reduced under conditions where light is separated into spectral components.

To achieve the object, the present invention provides a light source unit which is equipped with a wide band light source for generating wide band light and which is also equipped with an interference suppressing means for suppressing the interference at each wavelength component (constituent spectrum) of the wide band light. With the light source unit, interference in the constituent spectra can be reduced even in a spectrum analysis in which wide band light is separated into its spectral components. The term “wide band light” as used herein means light having a wavelength bandwidth of 100 GHz or more in which the power per unit wavelength is 3 dB less than the peak power or higher.

Also provided is a spectrum analyzer which is used for spectrum analysis conducted by irradiating light to a sample and which is equipped with a light source unit of the present invention. With this spectrum analyzer, it is possible to reduce interference under the conditions where the wide band light is separated into its spectral components.

### BRIEF DESCRIPTION OF THE DRAWINGS

FIG. 1 is a conceptional schematic diagram showing an embodiment of the spectrum analyzer of the present invention.

FIGS. 2 to 11 are conceptional schematic diagrams each showing an embodiment of coherence reduction means.

FIGS. 12 and 13 are conceptional schematic diagrams each showing an embodiment of light-path restricting means.

FIG. 14 is a conceptional schematic diagram showing an embodiment of an optical path modulator.

FIGS. 15A and 15B are conceptional schematic diagrams showing an embodiment of optical path modulator.

FIG. 16 is a conceptional schematic diagram showing an embodiment of optical path modulator.

FIG. 17 is a conceptional schematic diagram showing an embodiment of phase modulator.

FIGS. 18A and 18B are conceptional schematic diagrams showing an embodiment of phase modulator.

FIG. 19 is a conceptional schematic diagram showing an embodiment of phase modulator.

FIGS. 20A and 20B are conceptional schematic diagrams showing an embodiment of phase modulator, whereas FIG. 20A is a side sectional view and FIG. 20B is a front view taken from the incident direction of wide band light. FIG. 20C is a graph showing an example of spectrum of wide band light before and after passing a phase modulator.

FIGS. 21 to 26 are conceptional schematic diagrams each showing an embodiment of polarization modulator.

FIG. 27 is a conceptional schematic diagram showing an embodiment of intensity modulator.

FIGS. 28A and 28B are conceptional schematic diagrams showing an embodiment of the interference suppressing means provided in a spectrum analyzer.

### DETAILED DESCRIPTION OF THE INVENTION

The above-mentioned and other features, aspects, and advantages of the present invention will be better understood through the following description, appended claims, and accompanying drawings. In the explanation of the drawings, an identical mark is applied to identical elements and an overlapping explanation will be omitted.

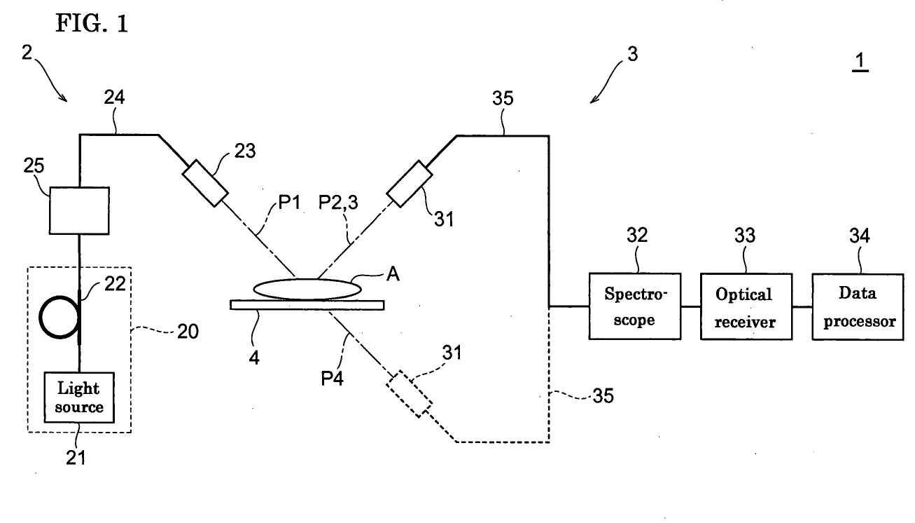

FIG. 1 is a conceptional schematic diagram showing an embodiment of the spectrum analyzer of the present invention. A spectrum analyzer 1 is equipped with a light source unit 2, a detector unit 3, and a sample stage 4 on which a sample A is placed. The light source unit 2, which is used for irradiating the sample A with wide band light P1 having a gentle spectral shape over the broad bandwidth, is equipped with a wide band light source 20 and an illuminating part 23. The detector unit 3, which is used for detecting the reflected light P2, scattered light P3 or transmitted light P4, each from the sample A, is equipped with a detecting part 31, a spectroscope 32, an optical receiver 33, and a data processor 34.

The wide band light source 20 may have a laser beam source 21, which generates an ultrashort pulse laser beam of several femtoseconds or a continuous laser beam, and a nonlinear optical medium 22 (nonlinear optical fiber) which is optically connected with the laser beam source 21. In the nonlinear optical medium 22, the spectral band width of the laser beam from the laser beam source 21 is expanded to two times or more by the nonlinear optical effect, and thereby the wide band light P1 (SC light in the present embodiment) is generated. The laser beam source 21 is preferably an active mode locking type or a passive mode locking type ultrashort pulse light source, for example. In that case, preferably the laser beam source 21 is constituted by a ring type resonator. Or, the laser beam source 21 may be an ultrashort pulse light source of passive mode locking type which is constituted by a solid laser of rare earth doped glass.

The wide band light source 20 is optically connected to an illuminating part 23 by a light guide 24. The illuminating part 23 is arranged at the vicinity of the sample A and the wide band light P1 is emitted onto the sample A through the light guide 24 and the illuminating part 23. FIG. 1 shows the case where the wide band light P1 is emitted at an angle of about 45° from the illuminating part 23 onto the sample A. However, the irradiation angle of the wide band light P1 is not limited to this. Also, the illuminating part 23 and the detecting part 31 may be the same one, and the wide band light P1 may be emitted at an angle of about 90° from the illuminating part 23 onto the sample A.

The detecting part 31 is arranged, in the vicinity of sample A, at a position where it can obtain the reflected light P2 and scattered light P3 of the wide band light P1 from the sample A or at a position (the part indicated by a broken line in the figure) where it can obtain the transmitted light P4 of the wide band light P1 through the sample A. The reflected light P2, the scattered light P3, or the transmitted light P4 incident on the detecting part 31 are transmitted to a spectroscope 32 through a light guide 35.

The spectroscope 32 separates reflected light P2, scattered light P3 or transmitted light P4 into a plurality of wavelength components. The output of the spectroscope 32 is optically connected to the optical receiver 33 and the optical receiver 33 converts the light intensity of each wavelength component into an electrical signal respectively. A spectrum analyzer may be provided instead of the spectroscope 32 and the optical receiver 33. An electrical signal output from the optical receiver 33 is fed into the data processor 34. The data processor 34 has the function of causing electrical signal data to be displayed in spectrum and also causing the display of the difference between this spectrum and the spectrum of the light source or the difference between this spectrum and the spectrum of a standard sample.

In a spectrum analysis, under the conditions where the wide band light is separated into its spectral components having a narrow wavelength band, the coherence increases. The transverse mode of the wide band light P1 generated by means of laser beams is single, and therefore in such a case, the wavelength components which have passed through different optical paths tend to interfere each other. On the other hand, the light source unit 2 is equipped with an interference suppressing means for suppressing the interference of each wavelength component of the wide band light P1. Hereinafter, various embodiments of the interference suppressing means will be described.

In the light source unit 2, the interference suppressing means may be a coherence reduction means 25 for reducing the coherence of the respective wavelength components included in the wide band light P1. By decreasing the coherence (coherent length) of each wavelength component included in the wide band light, the interference in each wavelength component can suitably be suppressed. Hereinafter, various embodiments of coherence reduction means 25 will be shown.

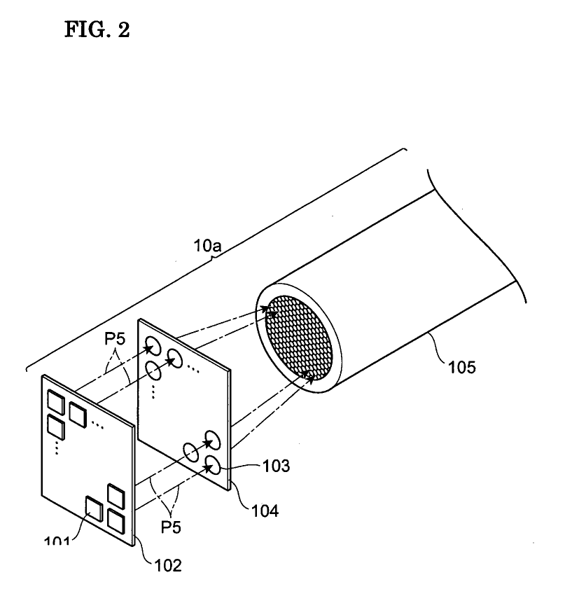

FIG. 2 is a conceptional schematic diagram showing an embodiment of coherence reduction means equipped with a plurality of light sources. A coherence reduction means 10a has a diode array 102, a lens array 104, and an image fiber 105 as a waveguide means. The diode array 102 includes a plurality of wide band light sources (LD having a bandwidth, e.g., Fabry-Perot type LD) 101 which are arranged two-dimensionally. The lens array 104 includes a plurality of lenses 103 and focuses a plurality of wide band light P5 emitted from LDs 101. The image fiber 105 guides and transmits the focused light of the wide band light P5 in a parallel manner. Generally, the phases of the wide band light P5 emitted from LDs 101 are varied. When the light output as the wide band light P1 from the image fiber 105 is emitted onto the sample A, each wavelength component of the emitted wide band light P1 includes a plurality of phase components and the coherence of each wavelength component suitably decreases.

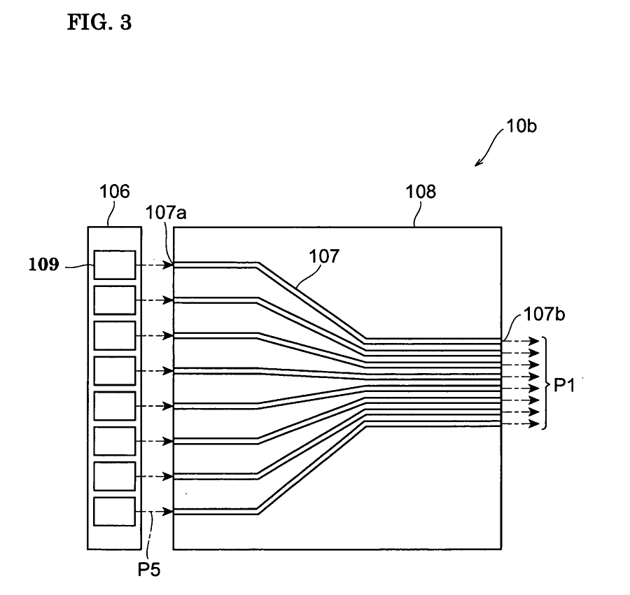

FIG. 3 is a conceptional schematic diagram showing another embodiment of the coherence reduction means using a plurality of light sources. A coherence reduction means 10b has a diode array 106 and a planer lightwave circuit (PLC) 108 as the waveguide means. The diode array 106 includes a plurality of SLDs 109 arranged one-dimensionally. The PLC 108, which includes a plurality of optical waveguide paths 107, guides and transmits in a parallel manner a plurality of wide band light P5 emitted from the diode array 106. The intervals between the incident ends 107a of the optical waveguide paths 107 are formed according to the intervals of the SLDs 109, and the intervals between the emitting ends 107b of the waveguide paths 107 are formed narrower than the intervals between the incident ends 107a. Each wide band light P5 which has traveled through the respective optical waveguide path 107 is emitted as wide band light P1 onto the sample A. With this structure also, by the effect similar to the coherence reduction means 10a, the coherence of each wavelength component suitably decreases.

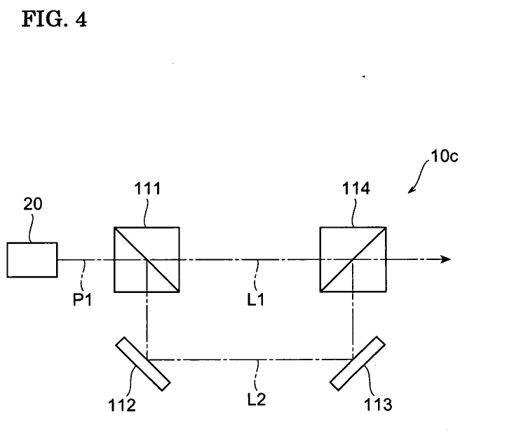

FIG. 4 is a conceptional schematic diagram showing an embodiment of the coherence reduction means which divides wide band light into a plurality of optical paths and gives phase difference. The coherence reduction means 10c has a splitter 111, mirrors 112 and 113, which are phase variation means, and a combiner 114. The splitter 111 is, for example, a polarized light beam splitter (PBS), and divides the wide band light P1, which is output from the wide band light source 20, into optical paths L1 and L2 according to the plane of polarization. The mirrors 112 and 113 are the means for causing a phase lag in the light propagating through the optical path L1 and the light propagating through the optical path L2. The combiner 114 is, for example, a PBS and multiplexes the light that has passed through the optical path L1 and the light that has passed through the optical path L2. With this structure, each wavelength component of the wide band light P1 includes a plurality of phase components and the coherence of each wavelength component suitably decreases.

It is more preferable to provide a wave plate between the wide band light source 20 and the splitter 111 in the coherence reduction means 10c and thereby to adjust the polarization mode of the wide band light P1 prior to the incidence onto the splitter 111 so that the coherence may further decrease. Also, preferably the optical path difference between the optical path L1 and the optical path L2 is greater than the coherent length of each wavelength component included in the wide band light P1.

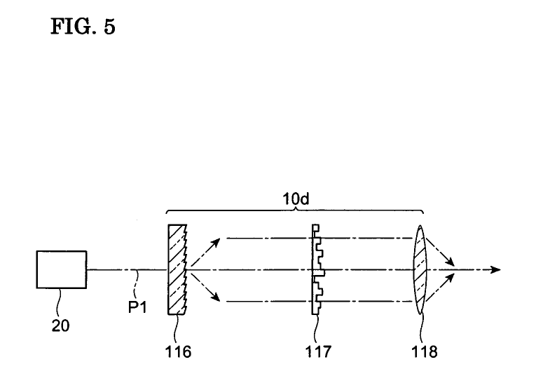

FIG. 5 is a conceptional schematic diagram showing another embodiment of the coherence reduction means which divides wide band light into a plurality of optical paths and affords a phase difference. The coherence reduction means 10d has a light separating means 116 for separating the wide band light P1 according to the wavelength, the phase varying means 117 for causing a phase lag in each separated wavelength component, and a light focusing means (lens) 118 for focusing light that has passed through the phase varying means 117. The light separating means 116 is preferably an arrayed waveguide grating (AWG) or a phase grating, for example. Preferably, the phase varying means 117 is, for example, an optical part such as a random phase plate in which the optical path length differs depending on the incident position. With such structure, each wavelength component of the wide band light P1 includes a plurality of phase components and accordingly the coherence of each wavelength component suitably decreases.

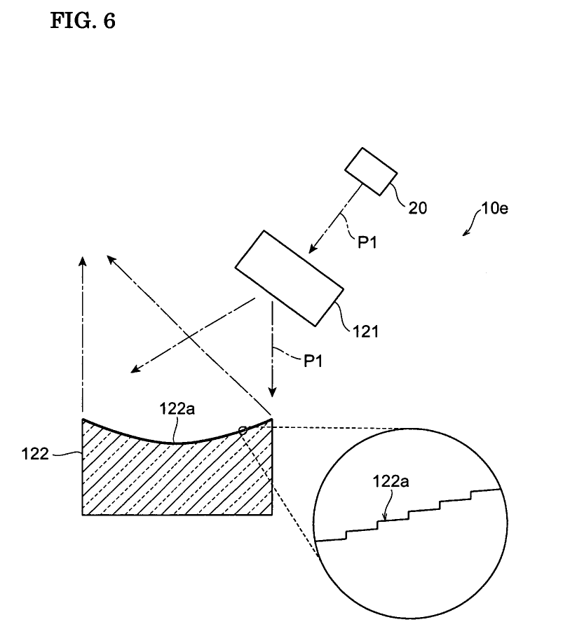

FIG. 6 is a conceptional schematic diagram showing another embodiment of the coherence reduction means which divides the wide band light into a plurality of optical paths and gives a phase difference. A coherence reduction means 10e has a widening means (diffusing plate 121) and a reflecting member 122. The diffusing plate 121 diffuses toward the reflecting member 122 the wide band light P1 that has been emitted from the wide band light source 20. As shown in the enlarged view, the light-reflecting face 122a of the reflecting member 122 includes unevenness formed with a size equivalent to the wavelength of the wide band light P1. Thus, the optical path length of the wide band light P1 differs depending on the differing incident position, and accordingly the reflecting member 122 works as a phase varying means to cause a phase lag in the light traveling through a plurality of optical paths. Also, the light-reflecting face 122a is formed like a concave mirror and functions as a light focusing means for focusing the widened light of the wide band light P1. With such a structure, each wavelength component of the wide band light P1 includes a plurality of phase components and the coherence of each wavelength component suitably decreases.

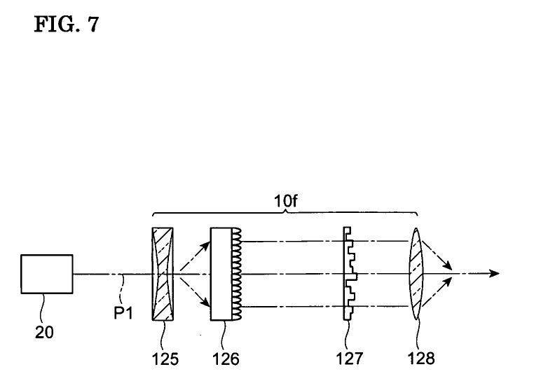

FIG. 7 is a conceptional schematic diagram showing another embodiment of the coherence reduction means which divides the wide band light into a plurality of optical paths and gives a phase difference. A coherence reduction means 10f has a widening means 125, a collimator 126, a phase varying means 127, and a light focusing means 128. The widening means 125 is, for example, a diffusing plate or a lens, and widens the wide band light P1 emitted from the wide band light source 20. The collimator 126 makes the diffused light to be parallel light. The phase varying means 127 is an optical part in which the optical path length differs depending on the incident position and the incident angle, such as a random phase plate, a hollow fiber, or integrating sphere, for example, and which causes a phase lag in the widened light of the wide band light P1 that travels in a plurality of optical paths. The light focusing means 128 is a lens, for example, and focuses the light which has passed through the phase varying means 127. With such a structure, each wavelength component of the wide band light P1 includes a plurality of phase components, and the coherence of each wavelength component suitably decreases.

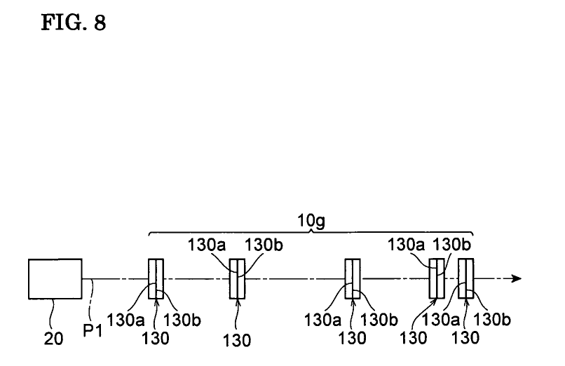

FIG. 8 is a conceptional schematic diagram showing another embodiment of the coherence reduction means which divides wide band light into a plurality of optical paths and gives a phase difference. A coherence reduction means 10g has a plurality of combining parts 130 arranged in series relative to the optical path of the wide band light P1 emitted from the wide band light source 20. Each combining part 130 includes a light reflector in a form of film with a first surface 130a on the side of wide band light source 20 and a second surface 130b opposite to the first surface 130a. The first surface 130a reflects a part of the wide band light P1 toward the wide band light source 20, and the second surface 130b reflects toward the first surface 130a the light reflected by the first surface 130a of the adjacent light combining part 130. With this structure, the wide band light P1 is reflected in a multiple manner between the respective adjacent combining parts 130, and accordingly each wavelength component of the wide band light P1 includes a plurality of phase components, and consequently the coherence of each wavelength component suitably decreases. This embodiment can be achieved simply by arranging a plurality of combining parts 130, and therefore it can be easily applied even in the case where an optical fiber is used as the light guide 24.

Preferably, the combining part 130 should have comparatively high reflectivity, for example, −10 dB or −5 dB. Also, it is preferable to provide an isolator between the wide band light source 20 and the proximate one of the combining parts 130 to prevent the wide band light P1 from returning to the wide band light source 20. It is sufficient to arrange at least two combining parts 130, and if three or more combining parts 130 are arranged, the intervals between the combining parts 130 should preferably differ from each other.

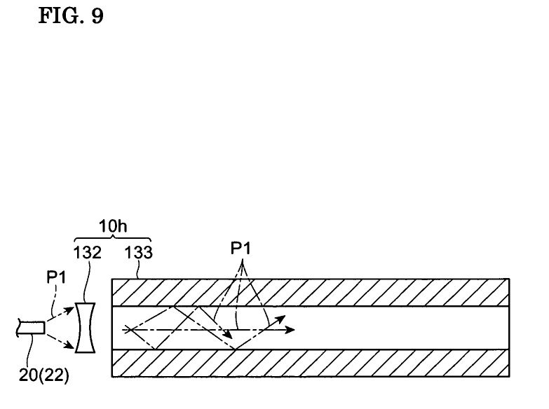

FIG. 9 is a conceptional schematic diagram showing another embodiment of the coherence reduction means which divides the wide band light into a plurality of optical paths and gives a phase difference. A coherence reduction means 10h has a beam expanding means 132 and a light transmitting means 133. The beam expanding means 132 is, for example, a concave lens and expands the beam diameter of the wide band light P1 emitted from the wide band light source 20. The light transmitting means 133, which is a plastic optical fiber having a large core diameter or a waveguide tube, for example, transmits in multiple modes the wide band light P1 that has passed through the beam expanding means 132. With such a structure, the optical path difference occurs between the modes in the light transmitting means 133, and accordingly each wavelength component of the wide band light P1 has a plurality of phase components, and thereby the coherence of each wavelength component suitably decreases. Also, more modes can be excited in the light transmitting means 133 by providing the beam expanding means 132 between the wide band light source 20 and the light transmitting means 133.

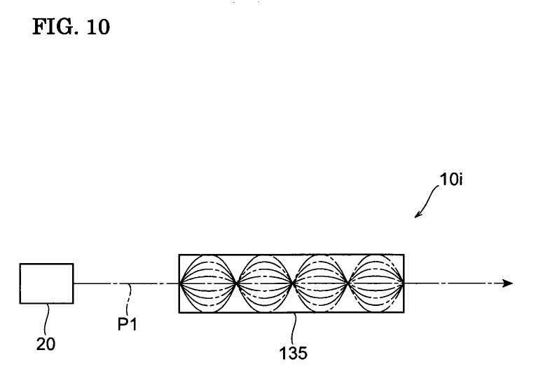

FIG. 10 is a conceptional schematic diagram showing another embodiment of the coherence reduction means which divides the wide band light into a plurality of optical paths and gives a phase difference. A coherence reduction means 10i has a light transmitting medium (light transmitting means) 135 which transmits in multiple modes the wide band light P1 emitted from the wide band light source 20. Preferably, the light transmitting medium 135 is, for example, a multimode fiber, a high NA fiber, or a photonic crystal fiber (PCF). The PCF used herein includes a holey fiber and a hollow fiber in addition to the fibers that achieve a band gap structure of light by means of the structure in which the dielectric constant periodically differs and that transmit light having a wavelength within the band gap. With such a structure, the optical path difference occurs between the modes in the light transmitting medium 135, and accordingly each wavelength component of the wide band light P1 includes a plurality of phase components, and thereby the coherence of each wavelength component suitably decreases.

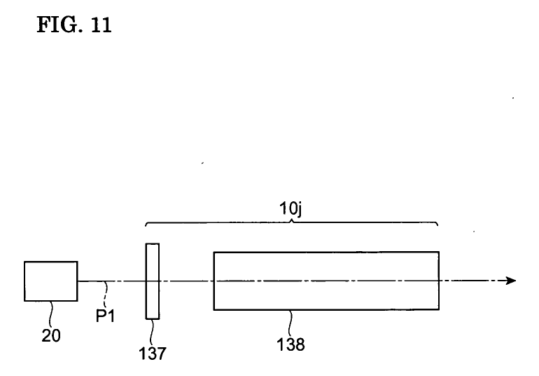

FIG. 11 is a conceptional schematic diagram showing another embodiment of the coherence reduction means which divides the wide band light into a plurality of optical paths and gives a phase difference. A coherence reduction means 10j has a birefringent medium 138 and a quarter-wave plate 137, which is optically connected between the birefringent medium 138 and the wide band light source 20. The birefringent medium 138 is a light transmitting medium, e.g., a polarization maintaining fiber (PMF), in which the refractive index differs depending on the plane of polarization of the incident light. The wide band light P1 of linearly polarized light is converted into circularly polarized light or elliptically polarized light by means of the quarter-wave plate 137 and is incident on the birefringent medium 138, in which the optical path difference occurs between polarized light components. With this structure, each wavelength component of the wide band light includes a plurality of phase components and accordingly the coherence of each wavelength component suitably decreases. When the birefringence medium 138 is PMF, it is possible and preferable to practically increase the course by adding a stress from the side at a plurality of points in the longitudinal direction.

The interference suppressing means may have a light-path restricting means for spatially limiting the optical path of each wavelength component contained in the wide band light P1. Each wavelength component of the wide band light P1 travels substantively a single optical path, resulting in suitable suppression of interference effect in each wavelength component. Hereinafter, various embodiments of the light-path restricting means will be shown.

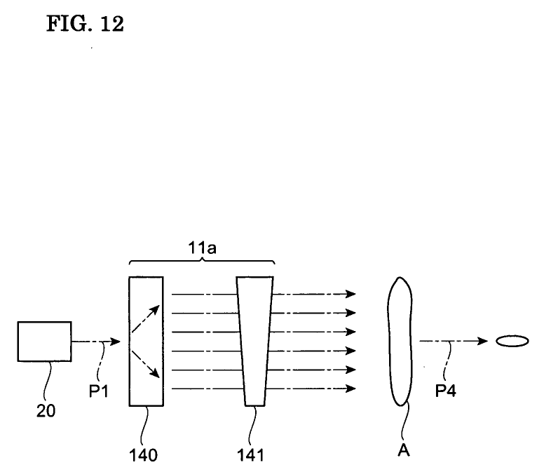

FIG. 12 is a conceptional schematic diagram showing an embodiment of the light-path restricting means. The light-path restricting means 11a has a widening means 140, which widens (expand) the beam diameter of the wide band light P1 emitted from the wide band light source 20, and a filtering device (two-dimensional filter) 141 which is optically connected to the widening means 140. The filtering device 141 is a device in which the transmitted wavelength or the reflected wavelength differs depending on the incident point of the wide band light P1, and an etalon filter or filter array having a thickness differing in the planar direction is preferable as the filtering device 141. When the wide band light P1 is transmitted through the filtering device 141 after the light has been widened with the widening means 140, the transmitted wavelength of the filtering device 141 is changed two-dimensionally and consequently each wavelength component is output as a beam having an extremely small diameter. Thus, the wavelength component (the transmitted light P4) which has passed through the sample A exhibits a spot-like circular shape having a small diameter. In this manner, according to the light-path restricting means 11a, the optical path of each wavelength component is substantively limited, and the interference effect can suitably be suppressed.

In order to irradiate the wide band light P1 onto all over the sample A, the filtering device 141 may be moved, or the transmitted wavelength distribution of the filtering device 141 may temporally be changed. The filtering device 141 shown in FIG. 12 is transmitting-type, but a reflection-type filtering device may be used. In that case, the reflected wavelength of the filtering device may differ depending on the incident point of the wide band light P1.

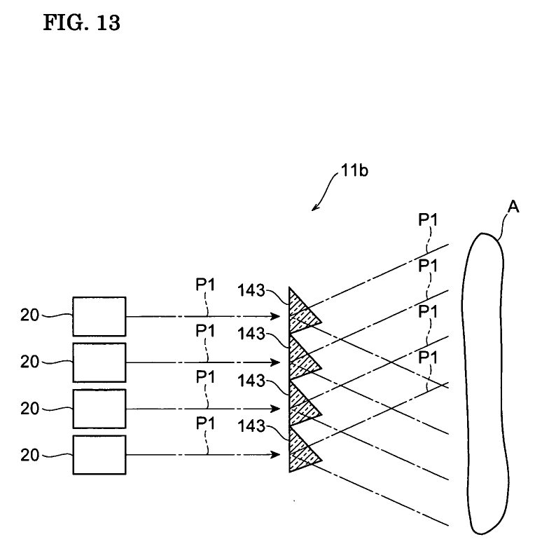

FIG. 13 is a conceptional schematic diagram showing an embodiment of the light-path restricting means. A light-path restricting means 11b has a plurality of light separating means 143. The light separating means 143 are disposed in parallel in a direction intersecting the incident direction of the wide band light P1 and are each optically connected to corresponding one of the wide band light sources 20. The light separating means 143 separate the wide band light P1 emitted from each wide band light source 20 according to the wavelength. It is preferable that the refractive index of the light separating means 143 have high wavelength dependence. The light separating means 143 is preferably a prism, for example. The wide band light P1 which has been separated by the light separating means 143 is irradiated onto the sample A.

When the wide band light is irradiated to the sample A using a plurality of wide band light sources, interferences may occur because an identical wavelength component of each wide band light source is irradiated onto the identical point of the sample. In such a case, it is possible to limit the optical path of each wavelength component by changing the irradiation direction of each wavelength component with the light separating means 143, e.g., prisms, provided as shown in FIG. 13. Thus, it is made possible to prevent identical wavelength components from being irradiated onto the identical points of the sample A and thereby to suppress the interferences effectively. Also, according to the structure shown in FIG. 13, the light irradiated onto each point of the sample A becomes a substantively broad bandwidth, and therefore an extra work for photographing can be made unnecessary.

The interference suppressing means may be achieved by means of modulating at least one of the followings with respect to the wide band light P1: an optical path, phase, wavelength, plane of polarization, and intensity. By such a method, the phase difference and the interference degree can temporally be leveled under the conditions where the light is separated into such components as observed in the spectrum analysis, and therefore the effect of the interference in the wavelength component over the spectrum analysis can suitably be suppressed. Preferably, the modulation period is equivalent to or less than the response speed of the optical receiver, or equivalent to or less than the sampling period in spectrum analysis, or the like. Hereinafter, various embodiments of such methods will be shown.

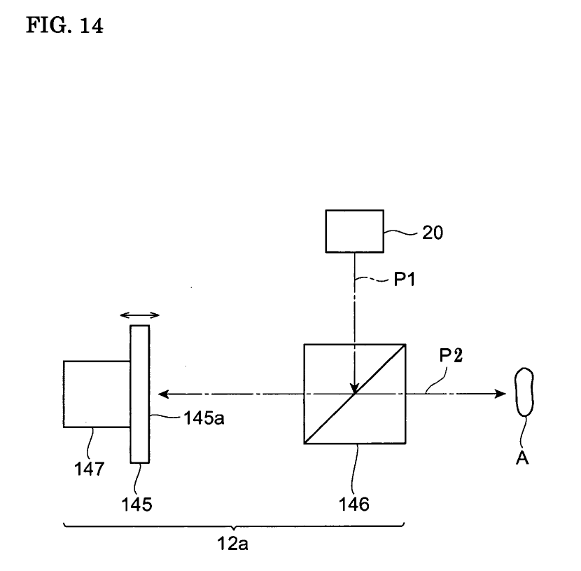

FIG. 14 is a conceptional schematic diagram showing an embodiment of the optical path modulator in which an optical medium or optical part that constitutes an optical path is vibrated using a mechanically driven actuator. The advantage of this method is that it can easily be achieved simply by installing an actuator on the structure of the optical path.

An optical path modulator 12a has a reflecting part (mirror) 145, a half mirror 146 which is optically connected to a light-reflecting face 145a of the reflecting part 145, and an actuator 147 which vibrates the reflecting part 145 to the direction at right angle relative to the light-reflecting face 145. The wide band light P1 emitted from the wide band light source 20 is reflected at the half mirror 146 so as to be incident on the reflecting part 145, is reflected at the light-reflecting face 146a, and then passes through the half mirror 146 so as to be irradiated onto the sample A. The vibration of the light-reflecting face 145a temporally modulates the optical path length that extends from the wide band light source 20 to the sample A. If reflected light P2, for example, is detected at a time sufficiently longer than this modulation period, the effect of the interferences is leveled under the conditions where the light is separated into the respective components. Accordingly, the effect of the interference in the wavelength component over the spectrum analysis can suitably be suppressed.

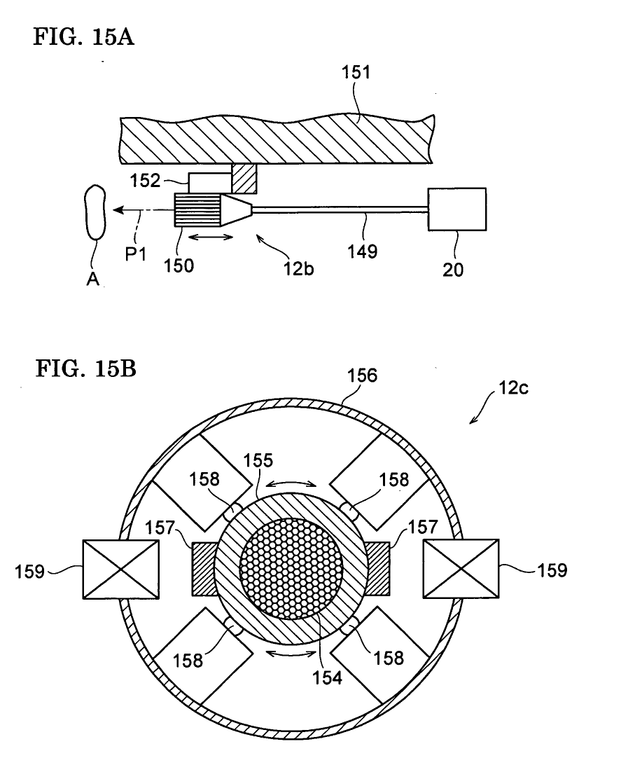

FIG. 15A is a conceptional schematic diagram showing another embodiment of the optical path modulator. An optical path modulator 12b has a light transmitting medium (optical fiber) 149, a light emitting end 150 provided at the tip of the light transmitting medium 149, and an actuator 152 provided between the light emitting end 150 and a supporting member 151. The light transmitting medium 149 transmits the wide band light P1 emitted from the wide band light source 20. The light emitting end 150 is arranged at the vicinity of the sample A, and the wide band light P1 emitted from the light emitting end 150 is irradiated onto the sample A. The actuator 152 modulates the distance between the light emitting end 150 and the sample A by vibrating the light emitting end 150 to the right-left direction in the figure. A piezoelectric element (piezo element) is preferable as the actuator 152. Thus, the optical path length extending to the sample A from the wide band light source 20 is temporally modulated by vibrating the light emitting end 150 in the direction of the optical path, and an effect similar to the optical path modulator 12a is achieved.

FIG. 15B is a conceptional schematic diagram showing another embodiment of the optical path modulator and shows the cross section thereof at a right angle to the optical path of the wide band light P1. An optical path modulator 12c has a light emitting end 154 which emits the wide band light P1, an inner cover 155, an outside cover 156, magnets 157, bearings 158, and electromagnetic coils 159. The inner cover 155 and the outside cover 156 are tubular members which are coaxial with the light emitting end 154. The magnets 157 are installed on the circumferential surface of the inner cover 155. The bearings 158, which are provided between the inner cover 155 and the outside cover 156, support the light emitting end 154 and the inner cover 155 in a manner allowing them to turn. The electromagnetic coils 159, which function as an actuator acting on the magnet 157 for affording rotational vibration to the light emitting end 154 and the inner cover 155, are provided at positions opposite the magnets 157 in the outside cover 156. The optical path length extending to the sample A from the wide band light source 20 is temporally modulated by causing the light emitting end 154 to vibrate rotationally around the optical path, and an effect similar to the optical path modulator 12a is achieved.

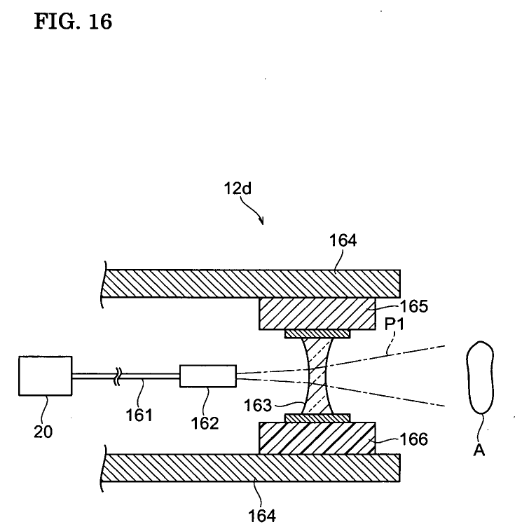

FIG. 16 is a conceptional schematic diagram showing another embodiment of the optical path modulator. An optical path modulator 12d has a light transmitting medium (optical fiber) 161, a light emitting end 162, a diffusion lens (concave lens) 163, a cover 164, an actuator 165, and an elastic member 166. The light transmitting medium (optical fiber) 161 transmits the wide band light emitted from the wide band light source 20. The light emitting end 162, which is provided at the tip of the light transmitting medium 161, emits the wide band light P1 to the sample A. The diffusion lens 163, which is placed between the light emitting end 162 and the sample A, is fixed with the actuator 165 and the elastic member 166 to the cover 164 covering the light emitting end 162 and the diffusion lens 163. The diffusion lens 163 spreads (widen) the wide band light P1 toward the sample A. The actuator 165 vibrates the diffusion lens 163 in a direction intersecting the optical axis of the wide band light P1 (that is, the vertical direction in FIG. 16). A piezoelectric element (piezo element) is preferable as the actuator 165.

Thus, the optical path length extending to the sample A from the wide band light source 20 is temporally modulated by vibrating the diffusion lens 163 in a direction intersecting the optical path, and an effect similar to the optical path modulator 12a is achieved. Also, since the size (dimension and mass) of the member (diffusion lens 163) to be driven is comparatively small in the structure shown in FIG. 16, the optical path of the wide band light P1 can be modulated at higher speed. In the case where a condensing lens (convex lens) is provided in the optical path of the wide band light P1, this condensing lens may be vibrated.

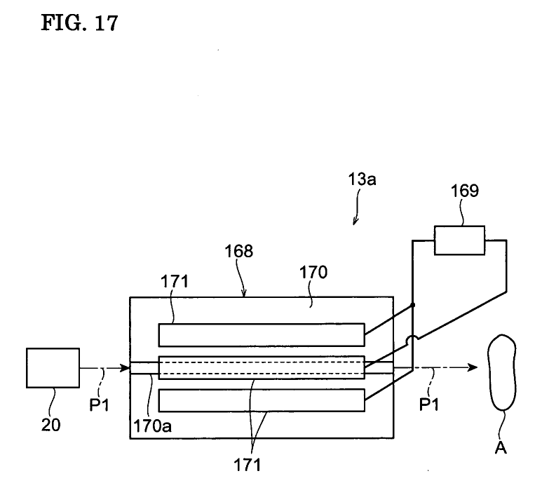

FIG. 17 is a conceptional schematic diagram showing an embodiment of the phase modulator. The phase modulator 13a has a phase modulation unit 168 and a driver 169 which drives the phase modulation unit 168. The phase modulation unit 168 is constituted by a lithium niobate (LiNbO₃) substrate 170, which has an optical waveguide path 170a for transmitting the wide band light P1 emitted from the wide band light source 20, and a plurality of electrodes 171, which are provided on the surface of the LiNbO₃ substrate 170. When an electric field is afforded to the LiNbO₃ substrate 170 by the electrodes 171, the refractive index of the optical waveguide path 170a of the LiNbO₃ substrate 170 is changed by Pockels effect, and accordingly the optical path length of the wide band light P1 changes. The electrodes 171 are electrically connected with the driver 169, and a modulating voltage is applied to each electrode 171 from the driver 169.

With such a structure, the phase difference in each constituent spectrum of the wide band light P1 is temporally modulated, and if the reflected light P2, etc. is detected taking time sufficiently longer than this modulation period, the phase differences in the constituent spectra are leveled. Therefore, the effect of the interference in the wavelength component over the spectrum analysis can suitably be suppressed. On the phase modulation unit 168, the arrangement of the electrodes may be different from that illustrated in the figure. Also, the substrate of the phase modulation unit 168 may be made of other various materials than LiNbO₃, provided that the materials have Pockels effect.

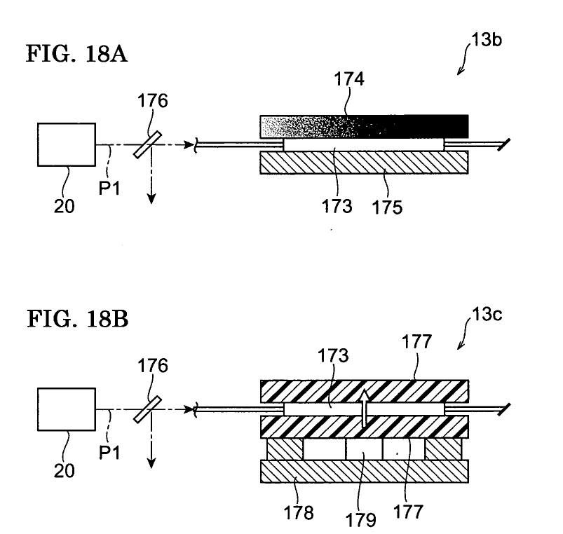

FIG. 18A is a conceptional schematic diagram showing another embodiment of the phase modulator. A phase modulator 13b has a chirped fiber Bragg grating (chirped-FBG) device 173, a temperature adjusting device 174, and a supporting member 175, with the FBG device 173 being sandwiched from both sides by the temperature adjusting device 174 and the supporting member 175. The chirped-FBG device is a FBG device in which the grating period is gradually changed and which has a periodic transmitting region. The temperature adjusting device 174 is, for example, a Peltier device or a heater, and is modulated and controlled by a driver (not illustrated in the figure) so that the temperature distribution thereof may change along the propagating direction of the wide band light P1. One end of the FBG device 173 is optically connected to the wide band light source 20 and the other end is terminated optically. The wide band light P1 reflected in the FBG device 173 is taken out into an illuminating part through a beam splitter 176, or the like.

With such a structure, the FBG device 173 expands or shrinks, and thereby the reflection position of each wavelength component is varied in the FBG device 173. Accordingly, the component wavelength of the wide band light P1 taken out from the FBG device 173 changes, causing changes in the phase difference, so that an effect similar to the phase modulator 13a is achieved.

FIG. 18B is a conceptional schematic diagram showing another embodiment of the phase modulator. A phase modulator 13c has a chirped-FBG device 173 having periodic transmitting regions, elastic members 177 sandwiching the FBG device 173 from both sides, a supporting member 178 supporting the elastic members 177 from the side, and an actuator 179. The actuator 179, which is arranged between the elastic members 177 and the supporting member 178, is driven by a driver (not illustrated in the figure), and distorts the elastic members 177 and the FBG device 173 periodically in a direction intersecting the direction of optical axis of the wide band light P1. The piezoelectric element (piezo element), for example, is preferable as the actuator 179.

With such a structure, the FBG device 173 periodically distorts, thereby modulating the inner stress of the FBG device 173, and consequently the reflection position of each wavelength component in the FBG device 173 changes. Accordingly, the component wavelength of the wide band light P1 taken out from the FBG device 173 changes, and the phase difference changes. Thus, an effect similar to the phase modulator 13a is achieved.

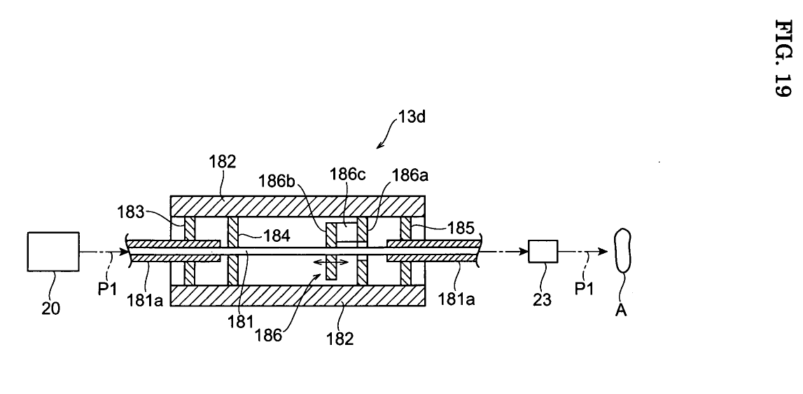

FIG. 19 is a conceptional schematic diagram showing an embodiment of the phase modulator. A phase modulator 13d has an optical fiber 181, a cover 182 which covers the optical fiber 181 with an interstice therebetween, holding members 183 to 185, and a stress applying part 186 which affords the optical fiber 181 with a stress in a longitudinal direction. The optical fiber 181, one end of which is optically connected to the wide band light source 20, transmits the wide band light P1, and the other end is optically connected to an illuminating part 23. The optical fiber 181 is covered with a covering material 181a, which is removed to expose the fiber main body only about the part of the optical fiber 181 that is covered with the cover 182. The holding members 183 and 185 are arranged respectively inside near the ends of the cover 182 so as to fix the part of the optical fiber 181 that is covered with the covering material 181a. The holding member 184, which is arranged between the holding members 183 and 185, fixes the part of the optical fiber 181 that is exposed from the covering material 181a.

The stress applying part 186 includes an annular holding member 186a for the cover side, a holding member 186b for the fiber side, and an actuator 186c arranged between the holding member 186a of the cover side and the holding member 186b of the fiber side. The holding member 186a for the cover side is fixed to the cover 182 and the optical fiber 181 is inserted in the central opening of the holding member 186a. The holding member 186b for the fiber side is arranged facing the holding member 186a for the cover side and is fixed to the optical fiber 181. The actuator 186c is driven by a driver (not illustrated in the figure) and vibrates, relatively in the direction of the optical axis of the wide band light P1 with respect to the holding member 186a of the cover side, the part of the optical fiber 181 that is fixed to the holding member 186b of the fiber side. Thus, the optical fiber 181 warps periodically in a longitudinal direction, and the inner stress of the optical fiber 181 is modulated. Accordingly, the inner stress of the optical fiber 181 is modulated, and consequently the refractive index of the optical fiber 181 is modulated, and the phase difference in each constituent spectrum of the wide band light P1 is temporally modulated.

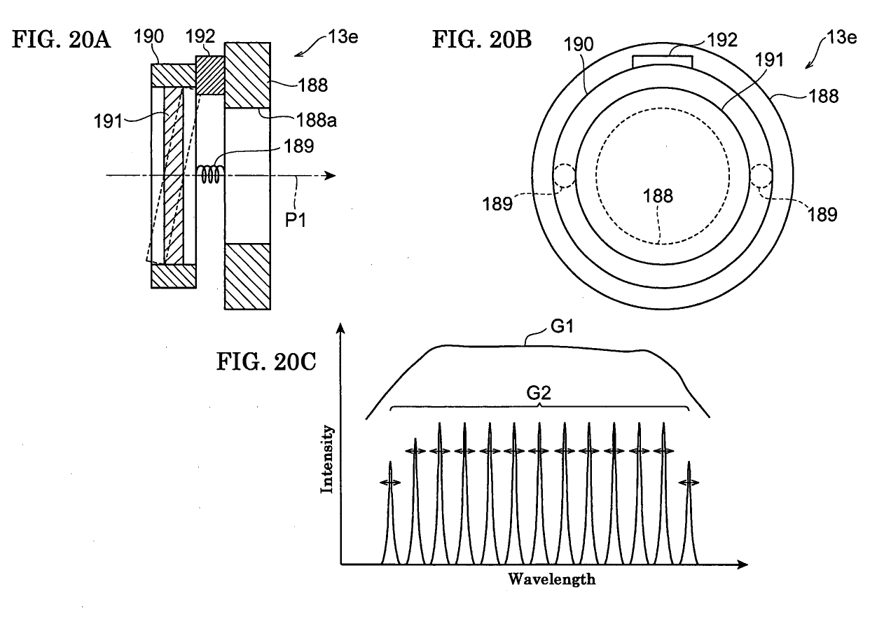

FIGS. 20A and 20B are conceptional schematic diagrams showing another embodiment of the phase modulator, whereas FIG. 20A is a side sectional view and FIG. 20B is a front view taken from the incident direction of wide band light. A phase modulator 13e has an annular supporting member 188 having an opening 188a, a frame material 190 attached to the supporting member 188 through a fulcrum 189 such as a spring or the like, a periodic filter 191, and an actuator 192. The periodic filter 191, which is a filtering device having periodicity with respect to a transmitted wavelength, is made of an etalon filter, for example, and is fixed to the inside of the frame material 190. Also, the actuator 192, which is provided at a position distanced from the fulcrum 189 and located between the supporting member 188 and the frame material 190, is periodically driven by a driver (not illustrated) so as to vibrate the frame material 190 in an access/recess direction relative to the supporting member 188. Thus, the periodic filter 191 vibrates using the fulcrum 189 as its fulcrum. Consequently, the incident angle of the wide band light P1 with respect to the periodic filter 191 is modulated.

FIG. 20C is a graph showing an example of spectra of the wide band light P1: (G1) is the spectrum existing before it passes through the phase modulator 13e; and (G2) is the spectrum existing after it has passed through the phase modulator 13e. The wide band light P1 exhibits such a transmission spectrum as the graph G2, since its periodic wavelength components only pass through the periodic filter 191 of the phase modulator 13e. The periodic wavelength component is determined by the incident angle of the wide band light P1 relative to the periodic filter 191. In this embodiment, since the incident angle of the wide band light P1 relative to the periodic filter 191 is modulated by the actuator 192, the central wavelength of each peak waveform that is included in the spectrum of the wide band light P1 changes up and down. That is, with the phase modulator 13e, the component wavelength of the wide band light P1 changes and the phase difference changes, and accordingly an effect similar to the phase modulator 13a is achieved.

With a structure other than those shown in FIGS. 17 to 20A and 20B, it is possible to suitably achieve the phase modulator by modulating the wide band light P1, using a device having an effect such as Pockels effect, optical Kerr effect, or acousto-optic effect, for example.

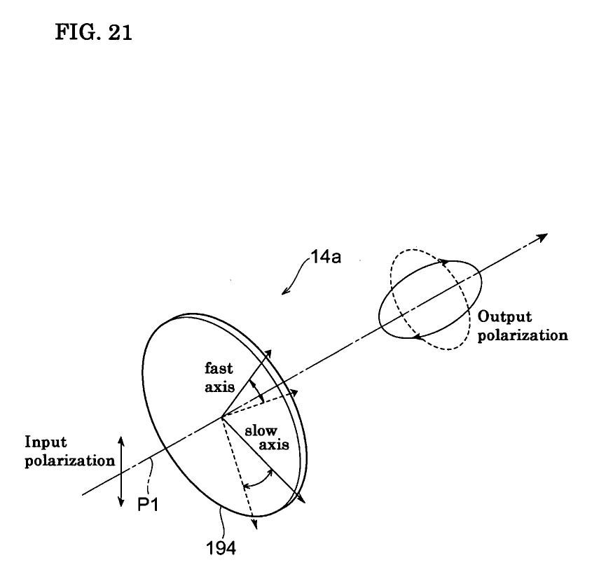

FIG. 21 is a conceptional schematic diagram showing an embodiment of the polarization modulator. A polarization modulator 14a has a device 194 which has birefringence. A quarter-wave plate, for example, is preferable as the device 194. In this case, the wide band light P1 of linearly polarized wave is output as a circularly polarized wave or an elliptically polarized wave. The device 194 is designed to vibrate by means of an actuator (not illustrated) in a revolving direction about the optical axis of the wide band light P1 as the central pivot. Thus, the plane of polarization of the wide band light P1 that passes through the device 194 is modulated. Accordingly, the interference in each constituent spectrum of the wide band light P1 changes periodically, and therefore, if reflected light P2, for example, is detected taking a time sufficiently longer than this modulation period, the interferences in the constituent spectra are leveled. Accordingly, the effect of the interference in the wavelength component over the spectrum analysis can suitably be suppressed.

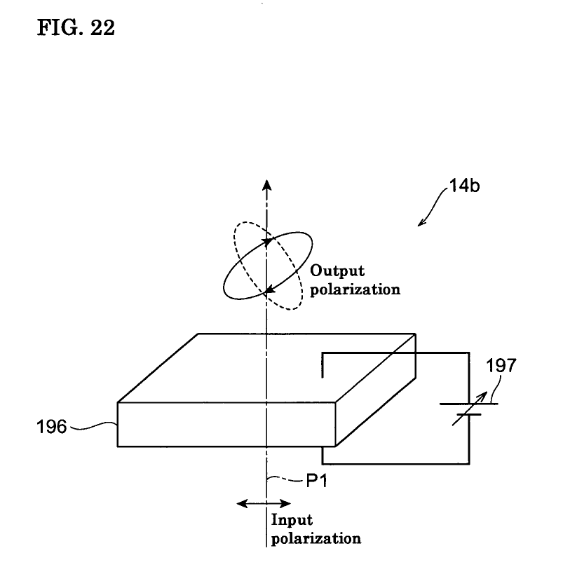

FIG. 22 is a conceptional schematic diagram showing another embodiment of the polarization modulator. A polarization modulator 14b has a liquid crystal device 196. When a voltage is applied to the liquid crystal device 196, the configuration of the inner liquid crystal structure changes, and the polarization mode of the transmitted light changes. Therefore, the plane of polarization of the wide band light P1 which passes through the liquid crystal device 196 is modulated by modulating the voltage applied to the liquid crystal device 196 both ends of which are connected to a variable voltage source 197. Thus, the interference in each constituent spectrum of the wide band light P1 changes periodically, and accordingly an effect similar to the polarization modulator 14a is achieved.

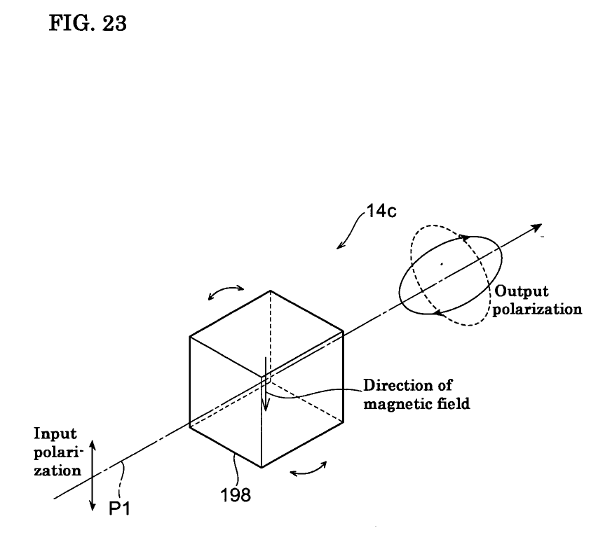

FIG. 23 is a conceptional schematic diagram showing another embodiment of the polarization modulator. A polarization modulator 14c has a dielectric 198. The dielectric 198 consists of a magnetic material (e.g., garnet) that is transparent to the wide band light P1, and the magnetic field is orthogonal to the axial direction of the wide band light P1. When the wide band light P1 passes through the dielectric 198, the plane of polarization of the wide band light P1 turns because of a Faraday effect, by the angle just corresponding to the strength of the magnetic field and the length of such passage. Also, the dielectric 198 is caused to vibrate by an actuator (not illustrated) in the revolving direction about the optical axis of the wide band light P1. Thus, the plane of polarization of the wide band light P1 which passes through the dielectric 198 is modulated, and the interference under in each constituent spectrum of the wide band light P1 changes periodically, and accordingly an effect similar to the polarization modulator 14a is achieved.

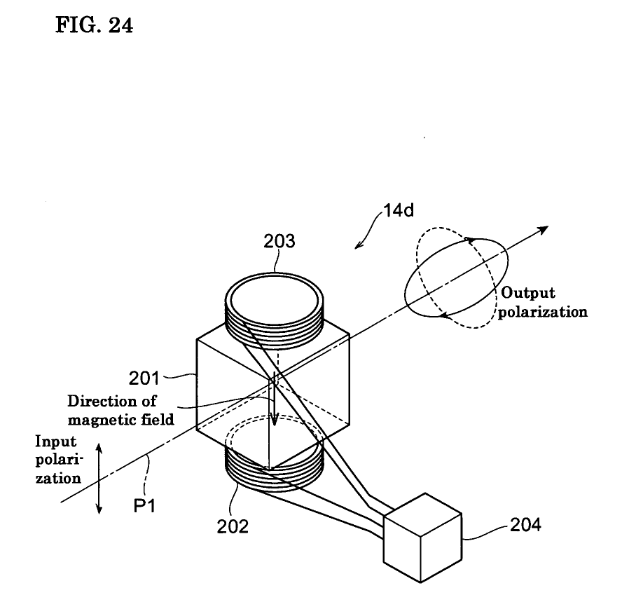

FIG. 24 is a conceptional schematic diagram showing another embodiment of the polarization modulator. A polarization modulator 14d has a non-magnetism dielectric 201 and electromagnetic coils 202 and 203 which are arranged facing the opposing side faces of the dielectric 201. When an electric current is supplied to the electromagnetic coils 202 and 203, a magnetic field is formed inside the dielectric 201, and the polarization mode of the light passing through the dielectric 201 is changed by a Faraday effect. In this embodiment, a driver 204, which is electrically connected with the electromagnetic coils 202 and 203, modulates an electric current supplied to the electromagnetic coils 202 and 203. Accordingly, the plane of polarization of the wide band light P1 passing through the dielectric 201 is modulated. Thus, the interference in each constituent spectrum of the wide band light P1 changes periodically, and accordingly an effect similar to the polarization modulator 14a is achieved.

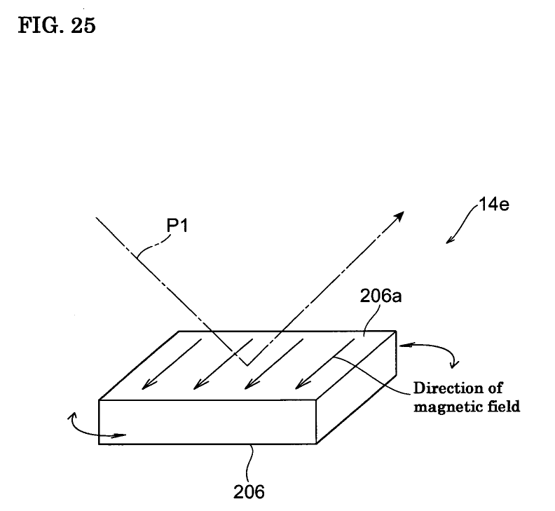

FIG. 25 is a conceptional schematic diagram showing another embodiment of the polarization modulator. A polarization modulator 14e has a magnetic body 206 having a light-reflecting face 206a which reflects the wide band light P1. The turn angle of the plane of polarization at the time when the wide band light P1 is reflected changes according to the direction of the magnetic field on the light-reflecting face 206a of the magnetic body 206 (magnetic Kerr effect). Also, the magnetic body 206 is rotationally vibrated by an actuator (not illustrated) about a normal direction of the light-reflecting face 206a. Thus, the plane of polarization of the wide band light P1 reflecting on the magnetic body 206 is modulated, and the interference in each constituent spectrum of the wide band light P1 changes periodically. Accordingly, an effect similar to the polarization modulator 14a is achieved.

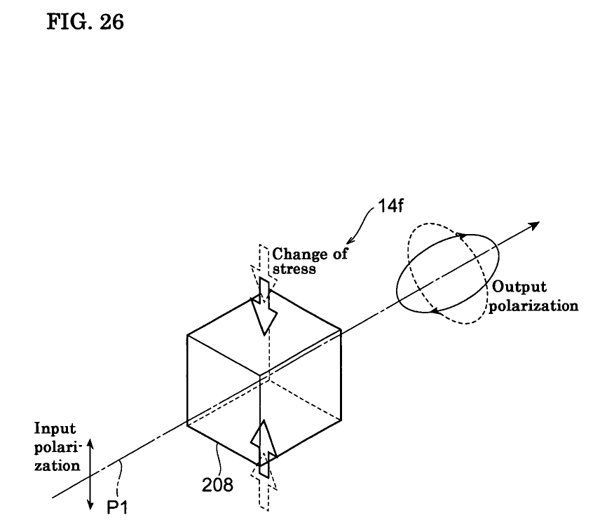

FIG. 26 is a conceptional schematic diagram showing another embodiment of the polarization modulator. A polarization modulator 14f has an optical elastic element 208. The optical elastic element 208 is a device which has a function of turning the plane of polarization by application of stress in a direction perpendicular to the direction of the optical axis of the wide band light P1. The optical elastic element 208 of this embodiment is subjected to force applied by an actuator (not illustrated) such that compression is periodically repeated. Thus, the plane of polarization of the wide band light P1 which passes through the optical elastic element 208 is modulated, and the interference in each constituent spectrum of the wide band light P1 changes periodically. Accordingly, an effect similar to the polarization modulator 14a shown in FIG. 21 is achieved.

When light that exhibits less variation in the intensity is used as a light source for generating the wide band light P1, the interference occasionally occurs between the light emitted at different times of emission. Therefore, it is possible to restrain the occurrence of interference by performing comparatively strong intensity modulation for the wide band light P1.

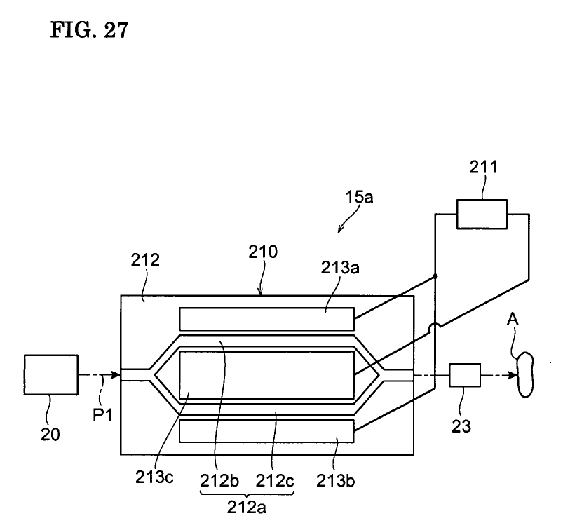

FIG. 27 is a conceptional schematic diagram showing an embodiment of the intensity modulator. An intensity modulator 15a has an intensity modulating unit 210 and a driver 211 for driving the intensity modulating unit 210. The intensity modulating unit 210 is formed of a lithium niobate (LiNbO₃) substrate 212 having an optical waveguide path 212a which transmits the wide band light P1, and a plurality of electrodes 213a, 213b, and 213c which are provided on the surface of the LiNbO₃ substrate 212. The optical waveguide path 212a includes two optical waveguide paths 212b and 212c which are provided in parallel. These optical waveguide paths 212b and 212c are combined at one end thereof on the LiNbO₃ substrate 212 and optically connected to the wide band light source 20. Also, the optical waveguide paths 212b and 212c are combined at the other end on the LiNbO₃ substrate 212 and optically connected to an illuminating part. The electrode 213a is arranged on the surface along the outside of the optical waveguide path 212b, and the electrode 213b is arranged on the surface along the outside of the optical waveguide path 212b, while the electrode 213c is arranged on the surface along the inner side of the optical waveguide paths 212b and 212c.

When equal electric fields are afforded to the optical waveguide paths 212b and 212c by the electrodes 213a, 213b, and 213c, interferences occur between the optical waveguide paths 212b and 212c, and the intensity of the wide band light P1 changes. The electrodes 213a to 213c are electrically connected with the driver 211, and a modulating voltage is applied from the driver 211 to the electrodes 213a, 213b, and 213c respectively.

With such a structure, the intensity of the wide band light P1 is temporally modulated, and accordingly the interference between the light emitted at the different timing of emission is reduced. Therefore, the effect of the interference in the wavelength component over the spectrum analysis can suitably be suppressed. In the intensity modulating unit 210 shown in FIG. 27, the arrangement of the electrodes is not limited to this embodiment, and others various arrangements can be applied.

The interference suppressing means described above are all provided in the light source unit 2. However, it is possible to place the interference suppressing means at the other part (particularly, the sample stage on which the sample A is placed) of the spectrum analyzer 1. For example, the respective means described above may be provided at a place separate from the light source unit 2. Also, the spectrum analyzer 1 may be structured in a manner such that the interference suppressing means includes a member having an opening for allowing at least either one of the following light to pass partially: the wide band light to be irradiated onto a sample and the light obtained from the sample by the irradiation of the wide band light.

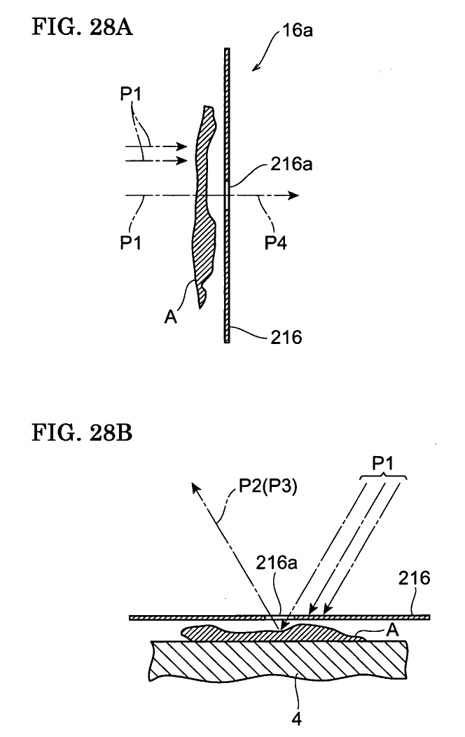

FIG. 28A is a conceptional schematic diagram showing an embodiment of the interference suppressing means which is provided in the spectrum analyzer of the present invention. An interference suppressing means 16a includes a slit plate 216 provided on the rear side of the sample A. The slit plate 216 has an opening (slit) 216a for partially allowing the passage of the light (transmitted light in this embodiment) obtained from the sample A out of the wide band light P1 irradiated from the surface side of the sample A. With this structure, only the light that has passed through the opening 216a is detected as the transmitted light P4. With such a structure, each wavelength component of the wide band light P1 is detected substantively by means of a single optical path, the interference of each wavelength component can suitably be suppressed.

Such a slit plate may be provided on the surface side of the sample A as shown in FIG. 28B. In this case, the opening 216a of the slit plate 216 partially allows the passage of the light reflected or scattered from the sample A, as well as the wide band light P1 that is irradiated from the surface side of the sample A. In such a structure also, it is possible to obtain an effect similar to the interference suppressing means 16a.

In the structure shown in FIGS. 28A and 28B, the slit plate 216 is preferably made of a material having an extremely low reflectivity to the wide band light P1. Also, it is preferable that the width of the opening 216a be sufficiently wider than the wavelength of the transmitted light to the extent in which strong diffraction of the transmitted light will not occur. Instead of the slit plate 216, a plate having a pinhole may be provided.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2007-015373 filed on Jan. 25, 2007, including the specification, claims, drawings, and summary, is incorporated herein by reference in its entirety.

What is claimed is:

1. A light source unit comprising:
a wide band light source for generating wide band light; and
an interference suppressing means for suppressing an interference at each wavelength component of the wide band light.

2. A light source unit according to claim 1, wherein
the interference suppressing means is a coherence reduction means for reducing the coherence of the respective wavelength components included in the wide band light.

3. A light source unit according to claim 2, wherein
the coherence reduction means has a plurality of wide band light sources and a waveguide means for transmitting, in a parallel manner, the wide band light emitted from the respective wide band light sources.

4. A light source unit according to claim 2, wherein
the coherence reduction means has a splitter, a phase variation means, and a combiner, and wherein the wide band light output from the wide band light source is divided by the splitter into a plurality of optical paths according to the plane of polarization, the phase variation means causes a phase lag in the light propagating through the plurality of optical paths, and the combiner multiplexes the light that has passed through the optical paths.

5. A light source unit according to claim 2,
wherein the coherence reduction means has a light separating means, a phase varying means, and a light focusing means, wherein the light separating means separates, according to the wavelength, the wide band light emitted from the wide band light source, the phase varying means causes a phase lag in each separated wavelength component, and the light focusing means focuses the light that has passed through the phase varying means.

6. A light source unit according to claim 2,
wherein the coherence reduction means has a widening means, a phase varying means, and a light focusing means, wherein the widening means widens the wide band light emitted from the wideband light source, the phase varying means causes a phase lag in the light included in the widened wideband light and traveling through the plurality of optical paths, and the light focusing means focuses the light that has passed through the phase varying means.

7. A light source unit according to claim 2,
wherein the coherence reduction means has a plurality of light reflectors, the light reflectors each having a first surface and a second surface, and wherein the first surface reflects toward the wide band light source a part of the wide band light emitted from the wide band light source, and the second surface reflects toward the first surface the light reflected by the first surface.

8. A light source unit according to claim 2,
wherein the coherence reduction means has a light transmitting means for transmitting in multiple modes the wide band light emitted from the wide band light source.

9. A light source unit according to claim 2,
wherein the coherence reduction means has a birefringent medium and a ¼ wavelength plate, and wherein the birefringent medium transmits wide band light emitted from the wide band light source, and the ¼ wavelength plate is optically connected between the birefringent medium and the wide band light source.

10. A light source unit according to claim 1,
wherein the interference suppressing means has a light-path restricting means for spatially limiting the optical path of each wavelength component contained in the wide band light.

11. A light source unit according to claim 10,
wherein the light-path restricting means has a widening means and a filtering device optically connected to the widening means, and wherein the widening means widens the wide band light emitted from the wide band light source, and the filtering device is such that the transmitted wavelength or the reflected wavelength differs depending on the incident point of the wide band light.

12. A light source unit according to claim 10,
wherein a plurality of wide band light sources are provided, and the light-path restricting means has a plurality of light separating means disposed in parallel in a direction intersecting the incident direction of the wide band light and each optically connected to the respective one of the wide band light sources, and wherein the light separating means separate according to the wavelength the wide band light emitted from each wide band light source.

13. A light source unit according to claim 1,
wherein the interference suppressing means has at least one of the following means: an optical path modulator for modulating the optical path of the wide band light; a phase modulator for modulating the phase of the wide band light; a wavelength modulator for modulating the wavelength of the wide band light, a polarization modulator for modulating the plane of polarization of the wide band light; and an intensity modulator for modulating the intensity of the wide band light.

14. A spectrum analyzer used for spectrum analysis conducted by irradiating light to a sample, the spectrum analyzer comprising a light source unit defined in claim 1.

15. A spectrum analyzer used for spectrum analysis conducted by irradiating light to a sample, the spectrum analyzer comprising a light source unit equipped with a wide band light source for generating wide band light and an interference suppressing means for suppressing the interference of each wavelength component of the wide band light, the interference suppressing means including a member having an opening for allowing at least either one of the following light to pass partially: the wide band light to be irradiated onto a sample and the light obtained from the sample by the irradiation of the wide band light.
